(19) United States
(12) Patent Application Publication
(10) Pub. No.: US 2026/0003526 A1
(43) Pub. Date: Jan. 1, 2026

(54) LOW LATENCY LOGICAL UNIT FOR A MEMORY SYSTEM

(71) Applicant: Micron Technology, Inc., Boise, ID (US)

(72) Inventors: Luca Porzio, Casalnuovo (NA) (IT); Antonio Mauro, Campania (NA) (IT)

(21) Appl. No.: 19/234,211

(22) Filed: Jun. 10, 2025

Related U.S. Application Data
(60) Provisional application No. 63/666,068, filed on Jun. 28, 2024.

(51) Int. Cl. G06F 3/06

(52) U.S. Cl. CPC G06F 3/0631; G06F 3/0619; G06F 3/0659; G06F 3/0685

(57) ABSTRACT

Methods, systems, and devices for low latency logical (L3A) unit for a memory system are described. For example, a logical unit, such as an L3Alogical unit or L3A logical unit number (LUN), may include a storage area for storing information for system swap operations, including, for example, a logical-block-address (LBA) range for one or more single-level-cells (SLCs). The logical unit may include a logical-to-physical (L2P) mapping table stored in a local memory of a memory system controller, such as in static random access memory (SRAM). In some examples, a reserved storage area may be overprovisioned, and the logical unit may be associated with a higher priority and a larger granularity than one or more other logical units. Further, one or more read-only (RO) descriptors stored to one or more registers, one or more provisioning parameters, or both, may be defined for the logical unit.

### CROSS REFERENCE

The present Application for Patent claims priority to U.S. Patent Application No. 63/666,068 by Porzio et al., entitled “LOW LATENCY LOGICAL UNIT FOR A MEMORY SYSTEM,” filed Jun. 28, 2024, which is assigned to the assignee hereof, and which is expressly incorporated by reference in its entirety herein.

### TECHNICAL FIELD

The following relates to one or more systems for memory, including a low latency logical unit for a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports a low latency logical unit for a memory system in accordance with examples as disclosed herein.

FIGS. 2A and 2B show examples of a system and an allocation diagram that support a low latency logical unit for a memory system in accordance with examples as disclosed herein.

FIG. 3 shows an example of a system that supports a low latency logical unit for a memory system in accordance with examples as disclosed herein.

FIG. 4 shows a block diagram of a memory system that supports a low latency logical unit for a memory system in accordance with examples as disclosed herein.

FIG. 5 shows a block diagram of a host system that supports a low latency logical unit for a memory system in accordance with examples as disclosed herein.

FIGS. 6 and 7 show flowcharts illustrating a method or methods that support a low latency logical unit for a memory system in accordance with examples as disclosed herein.

### DETAILED DESCRIPTION

A host system may run multiple applications using one or more random access memory (RAM) (e.g., dynamic RAM (DRAM)) devices and, if application pressure on a RAM allocation meets a threshold, may determine to deactivate (e.g., stop, shut down) one or more applications that are less active (e.g., “unused” by a user) to free up volatile memory. Some host systems may support system swap operations (e.g., memory paging) to extend RAM capabilities. For example, in place of deactivating applications, a host system may temporarily store application data to another storage area. In some examples, the application data may be temporarily stored to a non-volatile memory device, such as in not-and (NAND) memory. If application pressure is relieved, or a process is to be active at a later time, the data (e.g., swapped data) may be restored to RAM memory devices. Although system swap operations may be supported by some systems, system swap operations may lack further definition and may present opportunities for new methods to improve performance.

According to techniques described herein, a logical unit for system swap operations may be defined. For example, a low latency logical area (L3A) logical unit, which may be referred to or associated with a L3A logical unit number (LUN), may be defined to include a storage area, such as a single-level cell (SLC) reservoir, used for storing information for system swap operations. The logical unit may also include a logical-to-physical (L2P) mapping table that may be stored, for example, in a local memory of a memory system controller, such as in static random access memory (SRAM). In some examples, a reserved storage area may be overprovisioned (e.g., may include double a size of physical resources for a logical amount of storage, or double a requested storage) to increase a throughput in data storage and transfer operations. Further, one or more read-only (RO) descriptors and provisioning parameters may be defined in relation to an L3A logical unit.

Implementing an L3A logical unit including a defined storage area with L2P table management may decrease a latency for access operations by enabling system swap operations. Further, a latency may be reduced during both read and write operations by utilizing dedicated SLC blocks and SRAM L2P management, as SLCs and SRAM may be associated with relatively fast read and write times. Additionally, or alternatively, storing an L2P table, which may map swapped DRAM data, in SRAM may reduce a quantity of table management operations by omitting dirty shutdown robustness, improving performance and increasing a speed of operations. Utilizing dedicated SLC blocks may also increase a speed of operations and improve performance.

In addition to applicability in memory systems as described herein, techniques for a low latency logical unit for a memory system may be implemented to generally improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by defining a new logical unit type (e.g., an L3A logical unit type) for system swap procedures, which may increase DRAM performance and user satisfaction by reducing latency if data is swapped between DRAM and NAND, among other benefits. Further, by utilizing SRAM for L2P table storage and dedicated SLCs blocks for storing swapped data, a speed of operations may be increased and performance may be improved.

Features of the disclosure are illustrated and described in the context of systems, devices, and circuits. Features of the disclosure are further illustrated and described in the context of systems and allocation diagrams and flowcharts.

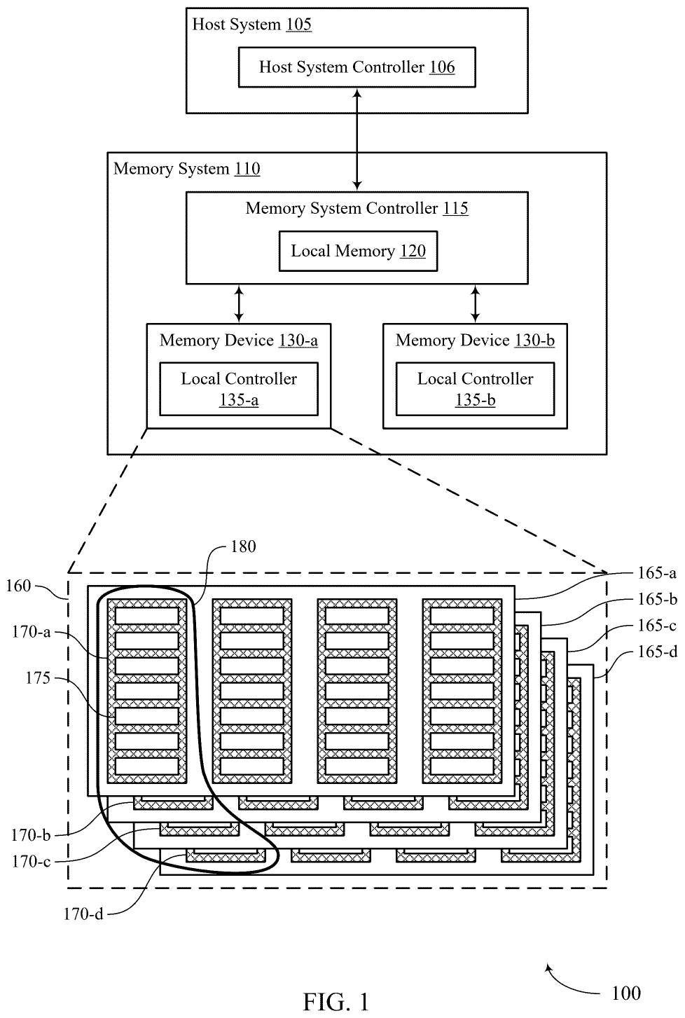

FIG. 1 shows an example of a system 100 that supports a low latency logical unit for a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (mNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as SLCs. Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update an L2P mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (mNAND) system.

As described herein, the host system 105 and the memory system 110 may support system swap operations (e.g., memory paging), including utilizing a logical unit with a defined storage area for system swap operation data, where the memory system 110 may define an L3A logical unit (e.g., L3A LUN) for storing application data from one or more applications run by the host system 105. For example, the host system 105 may be in communication with a volatile memory system, such as a DRAM memory system, as well as in communication with the memory system 110, which may be an example of a NAND system (e.g., an mNAND system), or many include NAND devices. While running one or more applications, the host system controller 106 may determine whether the DRAM is under a relatively heavy load (e.g., involving a relatively large quantity of data or using a high percentage of available DRAM for one or more applications). If the DRAM is under a heavy load, the host system controller 106 may transfer data for less active applications to one or more blocks of the memory system 110 (e.g., blocks 170, logical blocks, virtual blocks 180) that may be defined for the L3A logical unit. In some cases, the memory system 110 may store an L2P table to the local memory 120 (e.g., in SRAM), where the table may map LBAs of the one or more blocks to one or more physical addresses within one or more memory devices 130.

The system 100 may include any quantity of non-transitory computer readable media that support a low latency logical unit for a memory system. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

In some examples, operations and procedures described herein with respect to FIGS. 1-7 that are performed by a host system, such as the host system 105, may be implemented in instructions stored on memory of the host system and executed by a controller (e.g., a host system controller 106). Similarly, operations and procedures described herein with respect to FIGS. 1-7 that are performed by a memory system, such as the memory system 110, may be implemented in instructions or firmware stored on memory of the memory system (e.g., memory device 130) and executed by a controller (e.g., a memory system controller 115, a local controller 135).

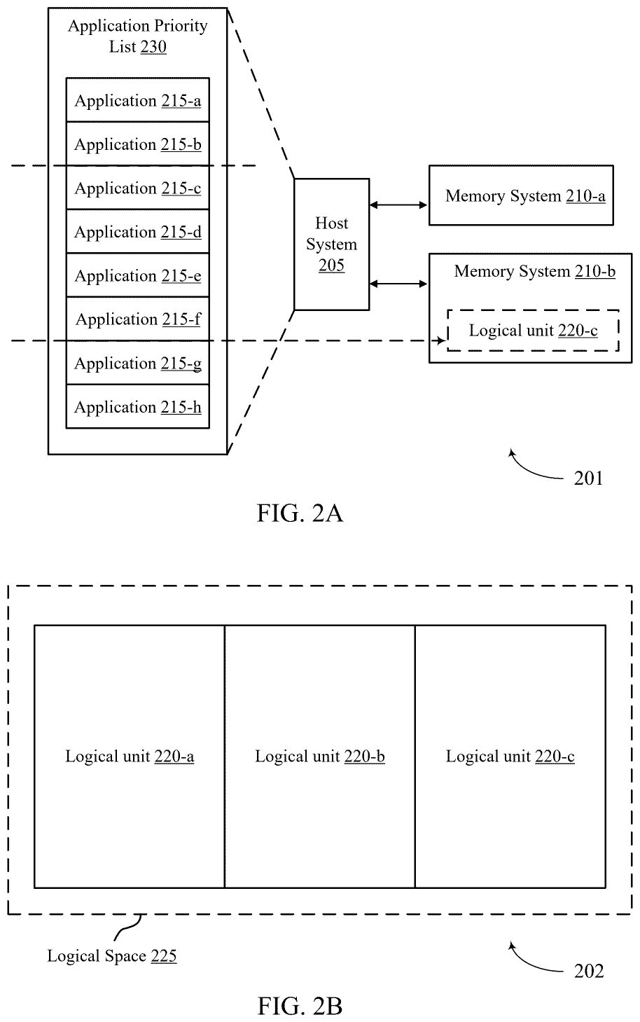

FIGS. 2A and 2B show examples of a system 201 and an allocation diagram 202 that support a low latency logical unit for a memory system in accordance with examples as disclosed herein. One or more aspects of the system 201 and the allocation diagram 202 may be implemented by one or more aspects of the system 100. For example, the system 201 may include a host system 205 in communication with multiple memory systems 210, including a memory system 210-a and a memory system 210-b, which may represent a host system 105 and memory systems 110, respectively, where a logical allocation of the memory system 210-b may be in accordance with the allocation diagram 202. In some examples, the system 201 and the allocation diagram 202 may support utilizing low latency logical units for system swap procedures as described herein.

For example, as illustrated in FIG. 2A, the memory system 210-a may include one or more volatile memory devices, such as a DRAM devices (e.g., may be a DRAM system), while the memory system 210-b may include one or more non-volatile memory devices, such as a NAND memory devices (e.g., may be a NAND system, an mNAND system).

Volatile memory of the memory system 210-a may be used to store data at run-time while the system 201 is powered on. For example, while powered on, the host system 205 may allocate one or more logical blocks (e.g., blocks 170, virtual blocks 180) across DRAM memory devices of the memory system 210-a for storing system information or application information. For example, after an application is commenced (e.g., a user input indicates to start an application 215), the host system 205 may allocate one or more logical blocks corresponding to volatile memory cells of the memory system 210-a to the application. In some cases, information may be stored for running a variety of different applications 215 (e.g., social network applications, video games, web browsers, other user-run applications, device-run applications) concurrently or within a time period, including applications 215-a, 215-b, 215-c, 215-d, 215-e, 215-f, 215-g, and 215-h. In some examples, memory may be deallocated at the close of an application.

In some cases, non-volatile memory of the memory system 210-b may be used to store data for long-term storage. For example, the host system 205 may store system information, application information, user information, among other data, to one or more non-volatile memory cells of one or more NAND memory devices of the memory system 210-b, which data may be persisted and maintained through multiple power cycles. Some data may be stored in the memory system 210-b according to various logical units 220, as illustrated in the diagram 202 of FIG. 2B. For example, at bootup, the memory system 210-b may allocate portions of an overall logical memory space 225 to multiple logical units 220, including logical units 220-a, 220-b, and 220-c. In some examples, a logical unit 220 may be an example of a partition (e.g., logical partition, physical partition) of available memory of the memory system 210-b. For example, a majority of the one or more logical units 220 may be examples of general purpose partitions (GPPs), which may be used for storing a variety of general purpose information, including user data or application data for long term storage. Additionally, or alternatively, one or more special partitions may be defined. For example, a logical unit 220 may be a boot partition (e.g., partition for data accessible early after bootup), a replay protected memory block (RPMB) (e.g., partition for data protected with keys), or a well-known logical unit (e.g., partition for task management and queries). In some cases, special logical units may include one or more defined memory spaces, such as a defined set of LBAs (e.g., pre-programmed or allocated at bootup).

In some examples, the system 201 may support system swap as a usage model to extend system DRAM capabilities. For example, if there is application pressure on a system DRAM allocation, such that a quantity of logical blocks allocated to DRAM is insufficient for one or more applications 215, the host system 205 may shut down one or more applications 215 that are relatively unused to free up space. In some examples, instead of shutting down applications 215, the host system 205 (e.g., an operating system running a controller of the host system 205) may swap (e.g., transfer) data for relatively unused processes to memory of the memory system 210-b, and may at a later time restore the data back to DRAM of the memory system 210-a (e.g., may restore application data to DRAM if application pressure is released or a process is to be active again at a later time). In some cases, application management or system swap operations may involve a priority of one or more applications 215. For example, the host system 205 may store an application priority list 230, where a priority of applications may involve one or more related factors (e.g., usage, system-based requirements, type of application). In an example, the applications 215-a through 215-f may utilize a majority of the available memory in the DRAM of the memory system 210-a (e.g., may apply heavy application pressure to a DRAM allocation), where the host system 205 may shut down, or swap, the applications 215-g and 215-h. In another example, the application 215-a may be run, but may utilize a relatively large quantity of DRAM (e.g., may be a video game involving high memory usage), and so the host system 205 may swap or shut down the applications 215-c through 215-h. In some cases, however, the host system 205 and the memory systems 210 may lack one or more defined spaces or parameters for use in system swap procedures, which may lead to inefficiency in operations, increase latency, and reduced performance.

As described herein, the system 201 may implement a logical unit defined for system swap procedures. For example, at system boot, the memory system 210-b may allocate a portion of the logical space 225 to an L3A logical unit, such as the logical unit 220-c. In some cases, the logical unit 220-c may include a defined (e.g., reserved) storage area that may be allocated at system boot, and that may represent a dedicated LBA range that may be cleared at initialization. During a system swap operation, data previously stored to DRAM for the applications 215-g and 215-h previously may be stored to one or more memory cells in NAND memory according to the logical allocation of the logical unit 220-c. In some cases, the logical allocation may include a quantity of LBAs for SLC blocks, where SLC memory cells of the allocation may be associated with relatively low latency and fast transition times. If a DRAM allocation of the memory system 210-a is under pressure and the system 201 decides to swap processes out of DRAM, the time to swap a process may directly impact a user experience, and so by allocating SLC blocks, a user experience may be improved (by providing reduced access times for both read and write operations to meet real-time deadlines). A dedicated memory space in NAND may thus be used as a DRAM extension. Further, volatile data content stored to the NAND may be lost in a case of a power off event (e.g., a battery runs out, asynchronous power loss (APL)), and so additional storage management operations may be omitted.

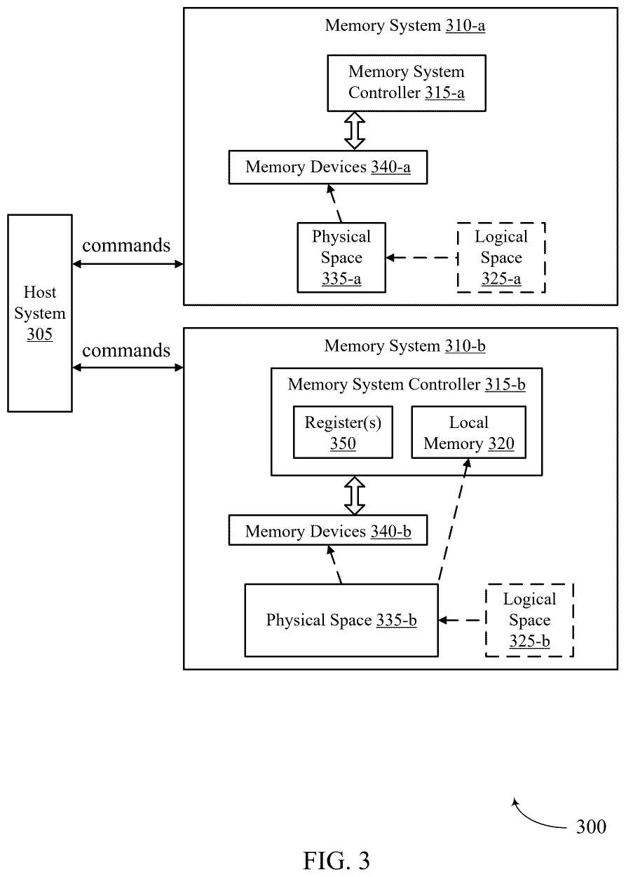

FIG. 3 shows an example of a system 300 that supports a low latency logical unit for a memory system in accordance with examples as disclosed herein. One or more aspects of the system 300 may be implemented by one or more aspects of the system 100, the system 201, and the allocation diagram 202. For example, the system 300 may include a host system 305 in communication with multiple memory systems 310, including a memory system 310-a and a memory system 310-b, which may represent a host system 105 or 205 and memory systems 110 or 210, respectively. In some examples, the system 300 may support architectures and defined parameters for implementing system swap procedures as described herein. In some examples, the operations described herein may be performed by one or more controllers of the host system 305 (e.g., via a host system controller 106), of the memory systems 310 (e.g., via memory system controllers 115, such as memory system controllers 315-a and 315-b), or of memory devices 340 (e.g., via local controllers 135).

For example, the memory systems 310-a (e.g., including one or more DRAM devices) and 310-b (e.g., including one or more NAND devices, such as a universal flash storage (UFS) device) may each include a memory system controller 315, including a memory system controller 315-a and 315-b, respectively. The memory system controllers 315-a and 315-b may each be coupled with and communicate with one or more memory devices 340. For example, the memory system 310-a may include one or more memory devices 340-a, which may be examples of DRAM memory devices or other volatile memory devices. Additionally, or alternatively, the memory system 310-b may include one or more memory devices 340-b, which may be examples of NAND memory devices or other non-volatile memory devices. In some examples, the memory system 310-b may be an example of an mNAND device. Additionally, or alternatively, the memory systems 310-a and 310-b may represent one or more mixed memory systems (including any combination of NAND, DRAM, SRAM, etc.), or may be part of a same memory system.

In some examples, the memory system 310-b may allocate (e.g., via the memory system controller 315-b) a logical memory space 325, such as a logical memory space 325-b, for the memory system 310-b along with a physical memory space 335, such as a physical memory space 335-b. The logical memory space 325-b (e.g., with a corresponding LBA range) and the physical memory space 335-b (e.g., with a corresponding range of physical addresses) may be allocated to a logical unit reserved for volatile memory storage, such as an L3A logical unit, or a swap logical unit. In some cases, the allocated memory spaces may include reserved storage for data of one or more DRAM operations performed at the memory system 310-a.

In some examples, after storing data for one or more applications to volatile memory cells in a physical memory space 335-a of the memory system 310-a (with corresponding logical memory space 325-a), the host system 305 may determine (e.g., via a host system controller, such as a host system controller 106) whether a threshold quantity of logical blocks (e.g., for a total or threshold DRAM capacity) is satisfied (e.g., greater than, greater than or equal to). For example, the host system 305 may determine if a sum of logical blocks of current applications and an estimated quantity of logic blocks of one or more new applications meets the threshold. If the threshold is satisfied, the host system 305 may transfer the data to one or more non-volatile memory cells of the memory system 310-b, where the non-volatile memory cells may be within the physical memory space 335-b and the logical memory space 325-b (e.g., NAND memory cells of one or more memory devices 340-b). Otherwise, if the threshold is not satisfied, the host system 305 may refrain from system swap operations. In some cases, the host system 305 may transfer one or more access commands, including read command and write commands, to perform the transfer operation and to read and store data to the memory system 310-a and the memory system 310-b. In some cases, the host system 305 may transfer the data back to one or more volatile memory cells of the memory system 310-a (e.g., using one or more read and write commands) if a later quantity of blocks fails to satisfy the threshold.

The allocated logical memory space 325-b and physical memory space 335-b may in some cases represent an SLC block reservoir including a quantity of reserved SLC blocks (e.g., reserved SLC blocks for pinning L3A data). The SLC blocks may in some cases represent one or more memory cells of one or more memory devices 340 or one or more memory cells of a local memory 320 of the memory system controller 315-b (e.g., SRAM). Overprovisioning, or allocating an amount of physical storage to a logical unit that is larger than a logical address space allocated to the logical unit, may in some cases be used to increase throughput in operations. For example, the physical memory space 335-b may store overprovisioned blocks equaling at least double a size of the logical space 325-b, or double a size requested by the memory system 310-b or the host system 305 (e.g., 100% overprovisioning). In some examples, overprovisioning may minimize delays for the memory system 310-b due to garbage collection (as additional memory cells may be available to write to while garbage collection is performed on other memory cells). Overprovisioning and utilization of SLCs may thus allow enough resources to enable writing contents at a maximum or near maximum throughput, for example, during system swap operations. Further, data stored to the L3A logical unit may in some cases considered volatile. For example, as the data stored to an L3A may correspond to DRAM data, the data may be lost upon system power cycle as no asynchronous power loss (APL) (e.g., unscheduled power event) or dirty shutdown robustness may be implemented. For example, the data may be flushed, or treated as random data upon bootup if still present in the local memory 320 or one or more memory devices 340-b.

In some cases, the memory system 310-b may store an L2P table to manage or track the information (e.g., data swap information) stored to the physical space 335-b. For example, the memory system 310-b may reserve space in the local memory 320 of the memory system controller 315 (e.g., SRAM), to store an L2P table (e.g., an SRAM L2P table) for the logical unit area. In some cases, the L2P table may be persisted. For example, during power management or a clean shutdown, the L2P table may be saved to NAND (e.g., to one or more of the memory devices 340-b), which may reduce SRAM power consumption at bootup. In some cases, a page size granularity of the L2P table may be enlarged to reduce an L2P table size. For example, one or more SLC pages may store a quantity of bits (e.g., 16 kilobytes (KB)), and one or more pointers of the L2P table may each point to a same quantity of bits (e.g., to a 16 KB page). By increasing a granularity of the L2P table, a quantity of pointers may be reduced compared to pointers of other L2P tables for other logical units with a smaller granularity (e.g., instead of 4 kilobyte (KB) pointers). A Read-Modify-Write technique may also be implemented to emulate a lower granularity (e.g., 4 KB) while remaining within a latency budget or latency value threshold, and while mitigating limited SRAM resources. In some cases, a Read-Modify-Write technique may involve reading one or more logical blocks of data, modifying, or overwriting a portion of the one or more blocks, and writing the one or more blocks back to one or more memory devices 340-b.

In some cases, one or more read-only (RO) descriptors may be defined. For example, one or more registers 350 (e.g., RO registers, ROM), may be defined to store RO descriptors. The one or more registers 350 may be stored in the local memory 320, or one or more memory devices 340-b, and may be read by a host system 305. For example, the one or more registers 350 may be accessed with one or more query commands (e.g., dedicated Query command from host system 305) as described by Table 1 below:

TABLE 1

| | Size | | | |
|---|---|---|---|---|
| Offset | (bits) | Name | Value | Description |
| 00h | 1 | bL3aSupport | 00h/01h | L3A feature support |
| 01h | 3 | Reserved | | |
| 04h | 4 | qL3aGranularUnitSize | Device | minimum granular unit size |
| | | | specific | for allocation of L3A LUN |
| 08h | 4 | qL3aMaxGranularUnitCount | Device | max quantity of units which |
| | | | specific | may be allocated |
| 0Ch | 4 | qL3aMaxReadLatency | Device | Max read latency Value (e.g., |
| | | | specific | in μsec) |
| 10h | 4 | qL3aMaxWriteLatency | Device | Max write latency Value (e.g., |
| | | | specific | in μsec) |

As described in Table 1, the one or more registers 350 may include a quantity of bits (e.g., up to 20 bits) to store RO descriptors bL3aSupport, Reserved, qL3aGranularUnitSize, qL3aMaxGranularUnitCount, qL3aMaxReadLatency, and qL3aMaxWriteLatency, among other parameters, which may indicate whether an L3A type (e.g., L3A LUN type, L3A logical unit type) is supported, one or more reserved bits, a minimum size of granularity units (e.g., for 256 KB alignment and 4 KB per LBA, a size may be 64), a maximum quantity of granularity units for the L3A logical unit, a maximum read latency, and a minimum write latency, respectively. In some cases, the value of bL3aSupport may indicate no support for L3A logical units via a first value (e.g., a ‘0’ bit, or 00h) and may indicate support for L3A logical units via a second value (e.g., a ‘1’ bit, or ‘01h’). Potential values of other RO descriptors may be device specific. The offsets may correspond to offsets in a quantity of bits within the one or more registers 350 that indicate the RO descriptors. In some examples, the host system 305 and/or the memory system 310-b may read the RO descriptors at initialization time (e.g., at bootup, at initialization of an overall device). Additionally, or alternatively, the RO descriptors described herein may include different variations of variables and values, where Table 1 may represent an exemplary table including example values.

Additionally, or alternatively, a logical unit type, or LUN type, may be defined as an L3A LUN (e.g., System Swap LUN) type, and may be identified and determined by one or more parameters, or provisioning fields, stored in one or more devices of the memory system 310-b. For example, a parameter bLUEnable may determine whether an L3A logical unit is enabled and a bPSASensitivite parameter may indicate production-state awareness (PSA) (e.g., sensitivity to one or more operations such as soldering or heating set to ‘00h’ to indicate lack of sensitivity). A bMemoryType parameter may indicate a type of memory (e.g., set to ‘02h’), a bDataReliability parameter may indicate a data reliability value (e.g., set to ‘00h’), and a bProvisioningType parameter may indicate a provisioning type value (e.g., ‘02h’). Further, a qLogicalBlockCount parameter may be defined to indicate a maximum allowed value of logical blocks as defined by the PO descriptor values qL3aMaxGranularUnitCount and qL3aGranularUnitSize. Notably, the qLogicalBlockCount parameter may indicate a quantity of logical blocks for the L3A logical unit, which may determine the values of qL3aMaxGranularUnitCount and qL3aGranularUnitSize, or how many granular allocation units are dedicated to the L3A logical unit. In some cases, the one or more parameters described herein may be declared or defined at the memory system 210-b, and may be used to define and allocate memory for an L3A logical unit (e.g., at bootup). In some cases, the RO descriptors, parameters, or both, may be locked to one or more users. Additionally, or alternatively, the parameters may be queried and read by the host system 305.

As system swap information that is stored to NAND memory and tracked by an L2P table, the system swap information and L2P table may be stored similar to volatile memory. For example, the memory system 310-b may refrain from persisting information or the L2P table, which may reduce L2P table management and improve performance as folding of “dirty” data, or data not yet persisted, to NAND may be omitted. Further, the operations described herein may result in relatively low latency in both read and write operations with a relatively high percentage of commands under a threshold latency value. Further, a threshold quality of service (QOS) may be achieved regardless of traffic or commands to other areas than the L3A by, for example, utilizing high priority commands (e.g., commands associated with L3A logical unit may have a higher priority than commands for other LUNs or logical units). Further, L3A logical units may be given higher priority management in a task queue.

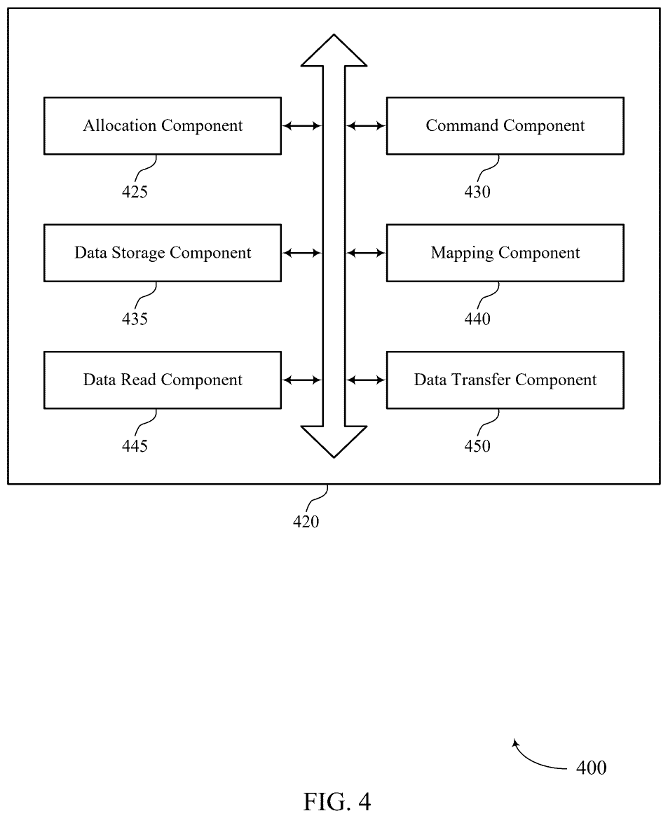

FIG. 4 shows a block diagram 400 of a memory system 420 that supports a low latency logical unit for a memory system in accordance with examples as disclosed herein. The memory system 420 may be an example of aspects of a memory system as described with reference to FIGS. 1 through 3. The memory system 420, or various components thereof, may be an example of means for performing various aspects of a low latency logical unit for a memory system as described herein. For example, the memory system 420 may include an allocation component 425, a command component 430, a data storage component 435, a mapping component 440, a data read component 445, a data transfer component 450, or any combination thereof. Each of these components, or components of subcomponents thereof (e.g., one or more processors, one or more memories), may communicate, directly or indirectly, with one another (e.g., via one or more buses).

The allocation component 425 may be configured as or otherwise support a means for allocating, to a logical unit of a plurality of logical units supported by the memory system, a logical memory space for the memory system and a physical memory space within the memory system, where the physical memory space allocated to the logical unit is larger than the logical memory space allocated to the logical unit, where the physical memory space includes a plurality of non-volatile memory cells configured to store one bit per memory cell, and where the logical unit is for storing data associated with one or more volatile memory operations. The command component 430 may be configured as or otherwise support a means for receiving a command indicating to store data associated with one or more logical addresses within the logical memory space allocated to the logical unit. The data storage component 435 may be configured as or otherwise support a means for storing, in response to the command, the data to one or more non-volatile memory cells within the physical memory space allocated to the logical unit.

In some examples, the mapping component 440 may be configured as or otherwise support a means for storing an L2P mapping table, associated with the logical unit, to a second plurality of memory cells of the memory system, the L2P mapping table mapping the one or more logical addresses associated with the data to one or more physical addresses corresponding to the one or more non-volatile memory cells to which the data is stored.

In some examples, the mapping component 440 may be configured as or otherwise support a means for refraining, in association with a non-scheduled power event for the memory system, from storing the L2P mapping table to a third plurality of memory cells of the memory system.

In some examples, the mapping component 440 may be configured as or otherwise support a means for storing the L2P mapping table to a third plurality of memory cells of the memory system in response to a scheduled power event for the memory system.

In some examples, a first granularity of the L2P mapping table associated with the logical unit is larger than one or more second granularities of one or more second L2P mapping tables associated with one or more second logical units of the plurality of logical units.

In some examples, the second plurality of memory cells to which the L2P mapping table is stored includes random access memory for a memory controller within the memory system.

In some examples, the command component 430 may be configured as or otherwise support a means for receiving a second command indicating to read the data associated with the one or more logical addresses. In some examples, the data read component 445 may be configured as or otherwise support a means for reading, in response to the second command, the data from the one or more non-volatile memory cells within the physical memory space allocated to the logical unit for storing data associated with one or more volatile memory operations. In some examples, the data transfer component 450 may be configured as or otherwise support a means for transferring the data to a host system.

In some examples, allocating the logical memory space and the physical memory space to the logical unit is in accordance with one or more parameters stored in the memory system.

In some examples, the one or more parameters include one or more RO descriptors stored to one or more registers of the memory system, the one or more RO descriptors including an indication of support for a type of the logical unit, a granular unit size, a maximum granular unit count, a maximum read latency, a maximum write latency, or any combination thereof.

In some examples, the one or more parameters include an indication of support for PSA, a memory type, a data reliability value, a logical block count, a provisioning type, or any combination thereof.

In some examples, a first priority of one or more first commands associated with the logical unit and including the command is higher than one or more second priorities of one or more second commands associated with one or more second logical units of the plurality of logical units.

In some examples, the logical memory space allocated to the logical unit has a first size. In some examples, the physical memory space allocated to the logical unit has a second size that is at least double the first size.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

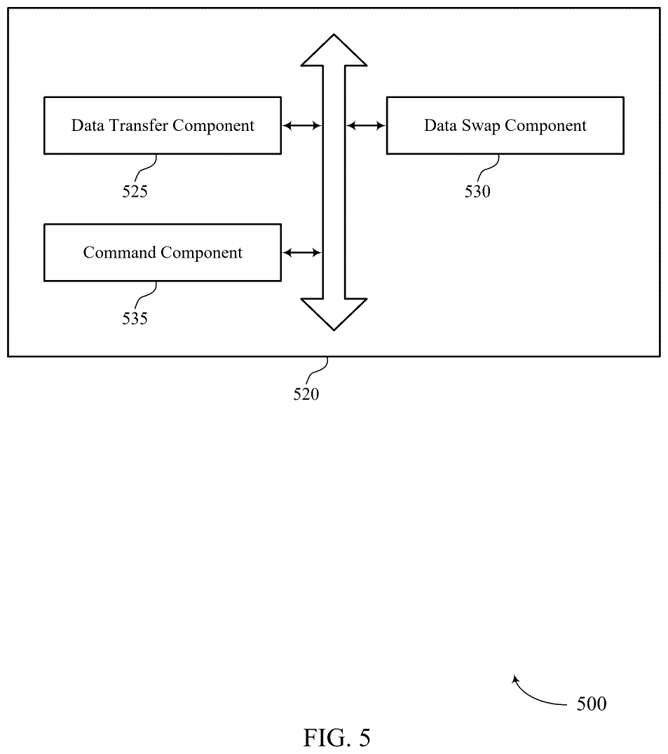

FIG. 5 shows a block diagram 500 of a host system 520 that supports a low latency logical unit for a memory system in accordance with examples as disclosed herein. The host system 520 may be an example of aspects of a host system as described with reference to FIGS. 1 through 3. The host system 520, or various components thereof, may be an example of means for performing various aspects of a low latency logical unit for a memory system as described herein. For example, the host system 520 may include a data transfer component 525, a data swap component 530, a command component 535, or any combination thereof. Each of these components, or components of subcomponents thereof (e.g., one or more processors, one or more memories), may communicate, directly or indirectly, with one another (e.g., via one or more buses).

The data transfer component 525 may be configured as or otherwise support a means for storing first data for one or more first applications to one or more volatile memory cells within a first physical memory space associated with a first logical memory space of a first memory system. The data swap component 530 may be configured as or otherwise support a means for determining whether a total quantity of logical blocks including a first quantity of logical blocks of the first logical memory space and an estimated second quantity of logical blocks, the estimated second quantity of logical blocks to store second data for one or more second applications, satisfies a threshold quantity of logical blocks. In some examples, the data transfer component 525 may be configured as or otherwise support a means for transferring, in accordance with determining that the total quantity of logical blocks satisfies the threshold quantity of logical blocks, the first data from the first memory system to one or more non-volatile memory cells within a second physical memory space allocated to a logical unit of a plurality of logical units of a second memory system, where the second physical memory space is larger than a second logical memory space, where the second physical memory space includes a plurality of non-volatile memory cells configured to store one bit per memory cell, and where the logical unit is for storing data associated with one or more volatile memory operations.

In some examples, to support transferring the data to the second memory system, the command component 535 may be configured as or otherwise support a means for transmitting a first command indicating to read the first data associated with one or more first logical addresses within the first logical memory space of the first memory system. In some examples, to support transferring the data to the second memory system, the command component 535 may be configured as or otherwise support a means for transmitting a second command indicating to store the first data associated with one or more second logical addresses within the second logical memory space allocated to the logical unit of the second memory system.

In some examples, the data swap component 530 may be configured as or otherwise support a means for determining whether a second total quantity of logical blocks fails to satisfy the threshold quantity of logical blocks. In some examples, the data transfer component 525 may be configured as or otherwise support a means for transferring, in accordance with determining that the second total quantity of logical blocks fails to satisfy the threshold quantity of logical blocks, the first data from the second memory system to one or more second volatile memory cells within the first physical memory space associated with the first logical memory space of the first memory system. In some examples, to transfer the first data to the first memory system, the command component 535 may be configured as or otherwise support a means for transmitting a third command indicating to read the first data associated with one or more second logical addresses within the second logical memory space allocated to the logical unit and transmitting a fourth command indicating to store the first data associated with one or more third logical addresses within the first logical memory space of the first memory system.

In some examples, a first priority of one or more first commands associated with the logical unit is higher than one or more second priorities of one or more second commands associated with one or more second logical units of the plurality of logical units.

In some examples, the described functionality of the host system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the host system 520, or various components thereof, may be implemented at least in part by instructions (e.g., stored in memory, non-transitory computer-readable medium) executable by such at least one processor.

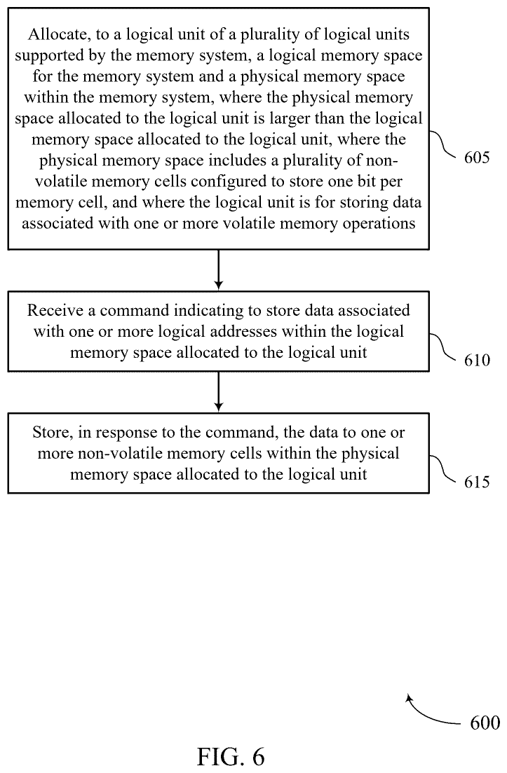

FIG. 6 shows a flowchart illustrating a method 600 that supports a low latency logical unit for a memory system in accordance with examples as disclosed herein. The operations of method 600 may be implemented by a memory system or its components as described herein. For example, the operations of method 600 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 605, the method may include allocating, to a logical unit of a plurality of logical units supported by the memory system, a logical memory space for the memory system and a physical memory space within the memory system, where the physical memory space allocated to the logical unit is larger than the logical memory space allocated to the logical unit, where the physical memory space includes a plurality of non-volatile memory cells configured to store one bit per memory cell, and where the logical unit is for storing data associated with one or more volatile memory operations. In some examples, aspects of the operations of 605 may be performed by an allocation component 425 as described with reference to FIG. 4.

At 610, the method may include receiving a command indicating to store data associated with one or more logical addresses within the logical memory space allocated to the logical unit. In some examples, aspects of the operations of 610 may be performed by a command component 430 as described with reference to FIG. 4.

At 615, the method may include storing, in response to the command, the data to one or more non-volatile memory cells within the physical memory space allocated to the logical unit. In some examples, aspects of the operations of 615 may be performed by a data storage component 435 as described with reference to FIG. 4.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for allocating, to a logical unit (e.g., L3A logical unit, L3A LUN) of a plurality of logical units supported by the memory system (e.g., a memory system including non-volatile memory, such as NAND memory), a logical memory space for the memory system (e.g., logical memory space 325) and a physical memory space within the memory system (e.g., physical memory space 335), where the physical memory space allocated to the logical unit is larger than the logical memory space allocated to the logical unit, where the physical memory space includes a plurality of non-volatile memory cells (e.g., NAND cells, other non-volatile memory cells) configured to store one bit per memory cell (e.g., SLC cells), and where the logical unit is for storing data associated with one or more volatile memory operations (e.g., swap data for DRAM operations); receiving a command (e.g., form a host system 305) indicating to store data associated with one or more logical addresses within the logical memory space allocated to the logical unit; and storing, in response to the command, the data to one or more non-volatile memory cells within the physical memory space allocated to the logical unit.
Aspect 2: The method, apparatus, or non-transitory computer-readable medium of aspect 1, further including operations, features, circuitry, logic, means, or instructions, or any combination thereof for storing an L2P mapping table, associated with the logical unit, to a second plurality of memory cells of the memory system, the L2P mapping table mapping the one or more logical addresses associated with the data to one or more physical addresses corresponding to the one or more non-volatile memory cells to which the data is stored.
Aspect 3: The method, apparatus, or non-transitory computer-readable medium of aspect 2, further including operations, features, circuitry, logic, means, or instructions, or any combination thereof for refraining, in association with a non-scheduled power event for the memory system, from storing the L2P mapping table to a third plurality of memory cells of the memory system (e.g., L2P may correspond to volatile data, where dirty data folding is omitted).
Aspect 4: The method, apparatus, or non-transitory computer-readable medium of any of aspects 2 through 3, further including operations, features, circuitry, logic, means, or instructions, or any combination thereof for storing the L2P mapping table to a third plurality of memory cells of the memory system in response to a scheduled power event for the memory system (e.g., L2P may be persisted to NAND).
Aspect 5: The method, apparatus, or non-transitory computer-readable medium of any of aspects 2 through 4, where a first granularity of the L2P mapping table associated with the logical unit is larger than one or more second granularities of one or more second L2P mapping tables associated with one or more second logical units of the plurality of logical units.
Aspect 6: The method, apparatus, or non-transitory computer-readable medium of any of aspects 2 through 5, where the second plurality of memory cells to which the L2P mapping table is stored includes random access memory for a memory controller within the memory system (e.g., SRAM of a local memory 320).
Aspect 7: The method, apparatus, or non-transitory computer-readable medium of any of aspects 1 through 6, further including operations, features, circuitry, logic, means, or instructions, or any combination thereof for receiving a second command indicating to read the data associated with the one or more logical addresses; reading, in response to the second command, the data from the one or more non-volatile memory cells within the physical memory space allocated to the logical unit for storing data associated with one or more volatile memory operations; and transferring the data to a host system.
Aspect 8: The method, apparatus, or non-transitory computer-readable medium of any of aspects 1 through 7, where allocating the logical memory space and the physical memory space to the logical unit is in accordance with one or more parameters (e.g., one or more provisioning parameters or provisioning fields) stored in the memory system.
Aspect 9: The method, apparatus, or non-transitory computer-readable medium of aspect 8, where the one or more parameters include one or more RO descriptors stored to one or more registers of the memory system, the one or more RO descriptors including an indication of support for a type of the logical unit, a granular unit size, a maximum granular unit count, a maximum read latency, a maximum write latency, or any combination thereof.
Aspect 10: The method, apparatus, or non-transitory computer-readable medium of any of aspects 8 through 9, where the one or more parameters include an indication of support for PSA, a memory type, a data reliability value, a logical block count, a provisioning type, or any combination thereof.
Aspect 11: The method, apparatus, or non-transitory computer-readable medium of any of aspects 1 through 10, where a first priority of one or more first commands associated with the logical unit and including the command is higher than one or more second priorities of one or more second commands associated with one or more second logical units of the plurality of logical units.
Aspect 12: The method, apparatus, or non-transitory computer-readable medium of any of aspects 1 through 11, where the logical memory space allocated to the logical unit has a first size and the physical memory space allocated to the logical unit has a second size that is at least double the first size (e.g., 100% or greater than 100% overprovisioning).

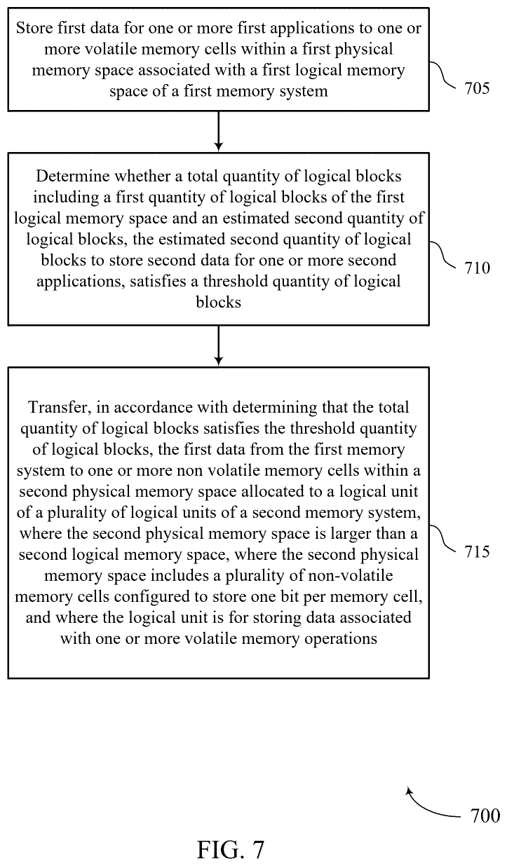

FIG. 7 shows a flowchart illustrating a method 700 that supports a low latency logical unit for a memory system in accordance with examples as disclosed herein. The operations of method 700 may be implemented by a host system or its components as described herein. For example, the operations of method 700 may be performed by a host system as described with reference to FIGS. 1 through 3 and 5. In some examples, a host system may execute a set of instructions to control the functional elements of the device to perform the described functions. Additionally, or alternatively, the host system may perform aspects of the described functions using special-purpose hardware.

At 705, the method may include storing first data for one or more first applications to one or more volatile memory cells within a first physical memory space associated with a first logical memory space of a first memory system. In some examples, aspects of the operations of 705 may be performed by a data transfer component 525 as described with reference to FIG. 5.

At 710, the method may include determining whether a total quantity of logical blocks including a first quantity of logical blocks of the first logical memory space and an estimated second quantity of logical blocks, the estimated second quantity of logical blocks to store second data for one or more second applications, satisfies a threshold quantity of logical blocks. In some examples, aspects of the operations of 710 may be performed by a data swap component 530 as described with reference to FIG. 5.

At 715, the method may include transferring, in accordance with determining that the total quantity of logical blocks satisfies the threshold quantity of logical blocks, the first data from the first memory system to one or more non-volatile memory cells within a second physical memory space allocated to a logical unit of a plurality of logical units of a second memory system, where the second physical memory space is larger than a second logical memory space, where the second physical memory space includes a plurality of non-volatile memory cells configured to store one bit per memory cell, and where the logical unit is for storing data associated with one or more volatile memory operations. In some examples, aspects of the operations of 715 may be performed by a data transfer component 525 as described with reference to FIG. 5.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:
Aspect 13: A method, apparatus, or non-transitory computer-readable medium including operations, features, circuitry, logic, means, or instructions, or any combination thereof for storing first data for one or more first applications to one or more volatile memory cells within a first physical memory space associated with a first logical memory space of a first memory system (e.g., within DRAM of memory system 310-a); determining whether a total quantity of logical blocks including a first quantity of logical blocks of the first logical memory space and an estimated second quantity of logical blocks, the estimated second quantity of logical blocks to store second data for one or more second applications, satisfies a threshold quantity of logical blocks (e.g., determine whether to swap in response to a level of application pressure on DRAM allocation); and transferring, in accordance with determining that the total quantity of logical blocks satisfies the threshold quantity of logical blocks, the first data from the first memory system to one or more non-volatile memory cells within a second physical memory space allocated to a logical unit of a plurality of logical units of a second memory system (e.g., within NAND of memory system 310-a), where the second physical memory space is larger than a second logical memory space (e.g., overprovisioned), where the second physical memory space includes a plurality of non-volatile memory cells configured to store one bit per memory cell, and where the logical unit is for storing data associated with one or more volatile memory operations.
Aspect 14: The method, apparatus, or non-transitory computer-readable medium of aspect 13, where transferring the data to the second memory system includes operations, features, circuitry, logic, means, or instructions, or any combination thereof for transmitting a first command (e.g., read command) indicating to read the first data associated with one or more first logical addresses within the first logical memory space of the first memory system and transmitting a second command (e.g., write command) indicating to store the first data associated with one or more second logical addresses within the second logical memory space allocated to the logical unit of the second memory system.
Aspect 15: The method, apparatus, or non-transitory computer-readable medium of any of aspects 13 through 14, further including operations, features, circuitry, logic, means, or instructions, or any combination thereof for determining whether a second total quantity of logical blocks fails to satisfy the threshold quantity of logical blocks (e.g., DRAM load is lessened); transferring, in accordance with determining that the second total quantity of logical blocks fails to satisfy the threshold quantity of logical blocks, the first data from the second memory system to one or more second volatile memory cells within the first physical memory space associated with the first logical memory space of the first memory system, where transferring the first data to the first memory system includes; transmitting a third command (e.g., read command) indicating to read the first data associated with one or more second logical addresses within the second logical memory space allocated to the logical unit; and transmitting a fourth command (e.g., write command) indicating to store the first data associated with one or more third logical addresses within the first logical memory space of the first memory system.
Aspect 16: The method, apparatus, or non-transitory computer-readable medium of any of aspects 13 through 15, where a first priority of one or more first commands associated with the logical unit is higher than one or more second priorities of one or more second commands associated with one or more second logical units of the plurality of logical units.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
allocate, to a logical unit of a plurality of logical units supported by the memory system, a logical memory space for the memory system and a physical memory space within the memory system, wherein the physical memory space allocated to the logical unit is larger than the logical memory space allocated to the logical unit, wherein the physical memory space comprises a plurality of non-volatile memory cells configured to store one bit per memory cell, and wherein the logical unit is for storing data associated with one or more volatile memory operations;
receive a command indicating to store data associated with one or more logical addresses within the logical memory space allocated to the logical unit; and
store, in response to the command, the data to one or more non-volatile memory cells within the physical memory space allocated to the logical unit.

2. The memory system of claim 1, wherein the processing circuitry is further configured to cause the memory system to:
store a logical-to-physical mapping table, associated with the logical unit, to a second plurality of memory cells of the memory system, the logical-to-physical mapping table mapping the one or more logical addresses associated with the data to one or more physical addresses corresponding to the one or more non-volatile memory cells to which the data is stored.

3. The memory system of claim 2, wherein the processing circuitry is further configured to cause the memory system to:
refrain, in association with a non-scheduled power event for the memory system, from storing the logical-to-physical mapping table to a third plurality of memory cells of the memory system.

4. The memory system of claim 2, wherein the processing circuitry is further configured to cause the memory system to:
store the logical-to-physical mapping table to a third plurality of memory cells of the memory system in response to a scheduled power event for the memory system.

5. The memory system of claim 2, wherein a first granularity of the logical-to-physical mapping table associated with the logical unit is larger than one or more second granularities of one or more second logical-to-physical mapping tables associated with one or more second logical units of the plurality of logical units.

6. The memory system of claim 2, wherein the second plurality of memory cells to which the logical-to-physical mapping table is stored comprises random access memory for a memory controller within the memory system.

7. The memory system of claim 1, wherein the processing circuitry is further configured to cause the memory system to:
receive a second command indicating to read the data associated with the one or more logical addresses;
read, in response to the second command, the data from the one or more non-volatile memory cells within the physical memory space allocated to the logical unit for storing data associated with one or more volatile memory operations; and
transfer the data to a host system.

8. The memory system of claim 1, wherein the processing circuitry is configured to cause the memory system to allocate the logical memory space and the physical memory space to the logical unit in accordance with one or more parameters stored in the memory system.

9. The memory system of claim 8, wherein the one or more parameters comprise one or more read-only descriptors stored to one or more registers of the memory system, the one or more read-only descriptors comprising an indication of support for a type of the logical unit, a granular unit size, a maximum granular unit count, a maximum read latency, a maximum write latency, or any combination thereof.

10. The memory system of claim 8, wherein the one or more parameters comprise an indication of support for production-state awareness (PSA), a memory type, a data reliability value, a logical block count, a provisioning type, or any combination thereof.

11. The memory system of claim 1, wherein a first priority of one or more first commands associated with the logical unit and comprising the command is higher than one or more second priorities of one or more second commands associated with one or more second logical units of the plurality of logical units.

12. The memory system of claim 1, wherein:
the logical memory space allocated to the logical unit has a first size, and
the physical memory space allocated to the logical unit has a second size that is at least double the first size.

13. A host system, comprising:
one or more interfaces comprising one or more signal paths operable for communications with one or more memory systems; and
processing circuitry coupled with the one or more interfaces and configured to cause the host system to:
store first data for one or more first applications to one or more volatile memory cells within a first physical memory space associated with a first logical memory space of a first memory system;
determine whether a total quantity of logical blocks comprising a first quantity of logical blocks of the first logical memory space and an estimated second quantity of logical blocks, the estimated second quantity of logical blocks to store second data for one or more second applications, satisfies a threshold quantity of logical blocks; and
transfer, in accordance with determining that the total quantity of logical blocks satisfies the threshold quantity of logical blocks, the first data from the first memory system to one or more non-volatile memory cells within a second physical memory space allocated to a logical unit of a plurality of logical units of a second memory system, wherein the second physical memory space is larger than a second logical memory space, wherein the second physical memory space comprises a plurality of non-volatile memory cells configured to store one bit per memory cell, and wherein the logical unit is for storing data associated with one or more volatile memory operations.

14. The host system of claim 13, wherein, to transfer the data to the second memory system, the processing circuitry is configured to cause the host system to:
transmit a first command indicating to read the first data associated with one or more first logical addresses within the first logical memory space of the first memory system; and
transmit a second command indicating to store the first data associated with one or more second logical addresses within the second logical memory space allocated to the logical unit of the second memory system.

15. The host system of claim 13, wherein the processing circuitry is further configured to cause the host system to:
determine whether a second total quantity of logical blocks fails to satisfy the threshold quantity of logical blocks; and
transfer, in accordance with determining that the second total quantity of logical blocks fails to satisfy the threshold quantity of logical blocks, the first data from the second memory system to one or more second volatile memory cells within the first physical memory space associated with the first logical memory space of the first memory system, wherein, to transfer the first data to the first memory system, the processing circuitry is configured to cause the host system to:
transmit a third command indicating to read the first data associated with one or more second logical addresses within the second logical memory space allocated to the logical unit; and
transmit a fourth command indicating to store the first data associated with one or more third logical addresses within the first logical memory space of the first memory system.

16. The host system of claim 13, wherein a first priority of one or more first commands associated with the logical unit is higher than one or more second priorities of one or more second commands associated with one or more second logical units of the plurality of logical units.

17. A non-transitory computer-readable medium storing code comprising instructions which, when executed by one or more processors of a memory system, cause the memory system to:
allocate, to a logical unit of a plurality of logical units supported by the memory system, a logical memory space for the memory system and a physical memory space within the memory system, wherein the physical memory space allocated to the logical unit is larger than the logical memory space allocated to the logical unit, the physical memory space comprises a plurality of non-volatile memory cells configured to store one bit per memory cell, and the logical unit is for storing data associated with one or more volatile memory operations;
receive a command indicating to store data associated with one or more logical addresses within the logical memory space allocated to the logical unit; and
store, in response to the command, the data to one or more non-volatile memory cells within the physical memory space allocated to the logical unit.

18. The non-transitory computer-readable medium of claim 17, wherein the instructions, when executed by the one or more processors of the memory system, further cause the memory system to:
store a logical-to-physical mapping table, associated with the logical unit, to a second plurality of memory cells of the memory system, the logical-to-physical mapping table mapping the one or more logical addresses associated with the data to one or more physical addresses corresponding to the one or more non-volatile memory cells to which the data is stored.

19. The non-transitory computer-readable medium of claim 18, wherein the instructions, when executed by the one or more processors of the memory system, further cause the memory system to:
refrain, in association with a non-scheduled power event for the memory system, from storing the logical-to-physical mapping table to a third plurality of memory cells of the memory system.

20. The non-transitory computer-readable medium of claim 18, wherein the instructions, when executed by the one or more processors of the memory system, further cause the memory system to:
store the logical-to-physical mapping table to a third plurality of memory cells of the memory system in response to a scheduled power event for the memory system.

21. The non-transitory computer-readable medium of claim 18, wherein a first granularity of the logical-to-physical mapping table associated with the logical unit is larger than one or more second granularities of one or more second logical-to-physical mapping tables associated with one or more second logical units of the plurality of logical units.

22. The non-transitory computer-readable medium of claim 18, wherein the second plurality of memory cells to which the logical-to-physical mapping table is stored comprises random access memory for a memory controller within the memory system.
